(19) United States
(12) Patent Application Publication
(10) Pub. No.: US 2008/0025515 A1
(43) Pub. Date: Jan. 31, 2008

(54) Systems and Methods for Digitally-Signed Updates

(76) Inventor: Jason Scott Coombs, Kohala, HI (US)

Correspondence Address: MCANDREWS HELD & MALLOY, LTD, 500 WEST MADISON STREET, SUITE 3400, CHICAGO, IL, 60661, US

(21) Appl. No.: 11/828,191

(22) Filed: Jul. 25, 2007

Related U.S. Application Data
(60) Provisional application No. 60/833,237, filed on Jul. 25, 2006.

(51) Int. Cl. H04L 9/28; H04L 9/30

(52) U.S. Cl. 380/277; 380/28

(57) ABSTRACT

Certain embodiments of the present invention provide a cryptographic system that enables updates with digital signatures, the signatures being created using an improved digital signature scheme, or using a conventional digital signature scheme that uses a one-way hash function algorithm during digital signature creation and verification, the updates being digitally-signed by a customer in addition to potentially being digitally-signed by a vendor. The updates being either programming instructions or a cryptographic key. The digital signatures associated with the updates being stored in a customer signature repository. The updates being delivered to a customer host along with the associated digital signature retrieved from a customer signature repository. Digital signatures being verified on the customer host using a customer public key. Acceptance of the updates being dependent on successful digital signature verification.

### RELATED APPLICATIONS

This application is related to, and claims the benefit of, Provisional Application No. 60/833,237, filed on Jul. 25, 2006, and entitled “A System or Method of Creating Cryptographic Command or Control Channels with Layers of Digital Signature Authentication or Verification of Digital Communications Enabling Remote Control Over, or Distribution of Arbitrary Reprogramming or Reconfiguration Instructions to, One or More General Purpose Programmable Electronic Devices.” The foregoing application is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to the distribution and verification of digitally-signed information such as digitally-signed software updates. More particularly, the present invention relates to digitally-signed updates.

A mechanism to realize digital signatures using an asymmetric cryptographic key pair, generally termed a public key and a private key, is a common feature of various electronic systems and prior art in the field of cryptology. The definition of digital signature is sometimes imprecise, as cryptographers tend to have one idea of the meaning of this term while engineers have another idea. To further complicate the search for a precise definition, the information security field routinely points out that definitions used by both cryptographers and engineers are foolish or simply wrong because prior art devices and methods that exist in the real world to create, transmit, and verify digital signatures are vulnerable in subtle ways that spoil cryptographers' and engineers' idealistic viewpoints on the subject.

However, using a precise definition of digital signature helps curtail the tendency to forget what they truly are when we imagine what they might be able to help us do to make digital technology safer or more reliable. The most precise definition of digital signature, common to all three of the fields of cryptology, engineering, and information security, is a cryptographic transformation involving at least one key, or employing at least one secret algorithm as a substitute for a key, in order to transform a message such that the result of the transformation can be compared against an expected result during a signature verification process to determine whether it is probable that the message was, at some time in the past, under the control of an entity that was capable of transforming the message such that the expected result of said comparison would be obtained by an entity that attempts to verify the digital signature in the future. Such entities can be people or devices that are capable of following detailed instructions to process data for example. Most digital signature schemes only ensure a degree of probability, they don't conclusively prove that a particular message was transformed using a particular key.

Typically, digital signatures are easy to compute and easy to verify because they involve two keys (or algorithms) comprised of mathematically-related numerical values (or formulae) that enable the holder of a second key to compute a digital signature verification result from the output of a prior cryptographic transformation. The holder of the second key performs such computation by transforming the digital signature, which itself is merely the output of a prior transformation of a message. The result that is expected when a digital signature is transformed is easy for the holder of a first key to ensure that the holder of the second key can obtain, computationally, if the digital signature in fact corresponds to the original message, assuming the holder of the second key has a true and correct copy of the original message, and where the second key is the correct key (or algorithm) related mathematically to the first key (or algorithm). We say that digital signatures are easy for parties who hold the appropriate keys to create and verify, even though the algorithms are often complex, because it is considered very hard for an adversary to discover the keys by analyzing the output of cryptographic transformations that utilize the keys, and because it is extremely hard for a party who lacks the keys to ever create or verify digital signatures. It's easy with the keys but very hard without them.

In some systems, algorithms may be used as keys. That is, rather than using a numerical value as a key, an algorithm is used instead. An algorithm can have a related algorithm just as keys used to create and verify digital signatures can be related. When algorithms are used as keys, at least one of the algorithms is typically kept secret in order for the digital signature system to function effectively. Thus, as used herein, a key may refer to a value or an algorithm, as described above. That is, the term key is used to mean either or both.

It is commonly believed that only a holder of the first key is able to perform the cryptographic transformation needed in order to produce a digital signature such that a holder of the second key could then compute the expected result from the digital signature when attempting to verify the digital signature using the second key and a copy of the original message. This quality of such a system, binding a message and a first key in such a way that only a second key can verify that the first key and the message were so bound, is part of what gives a digital signature its utility as the digital signature is a simple mathematical proof to demonstrate probability of such binding. Keeping it simple to verify a digital signature is a typical design goal of digital signatures, while ensuring that it remains extremely difficult to discover the first key given only the second key, the digital signature, and the original message, is another typical design goal. A scheme that achieves both goals simultaneously gives meaning, purpose, and value to digital signatures.

Typical digital signature methods use asymmetric encryption, meaning that a second key, a public key, is able to decrypt a cryptographic transformation produced using a first key, a private key. This is distinct from symmetric encryption in which the same secret key is used for both encryption and decryption.

To compute a digital signature, a holder of the first key encrypts some data, typically a hash code value that is computed by using a one-way function that digests a message to be signed into a numeric value of a data length usually shorter than that of the message being signed. By encrypting a small amount of data that results from a one-way hash function involving the message being signed, instead of encrypting the entire message, the creators of such digital signature schemes believe the scheme is made more efficient because the signature does not take up as much data storage space as the original message. This reasoning makes some sense for slow or limited-capacity systems, but is similar to faulty reasoning that resulted in the Y2K bug.

In many current systems, however, the use of one-way hash functions makes it possible to forge digital signatures in a variety of ways that would not be possible if the entire message were simply encrypted using the first key. Encrypting the entire message with the digital signature private key would provide greater resistance to forged digital signatures, but most engineers are satisfied today with merely periodically improving the one-way function hash algorithms that are used in digital signature systems rather than burdening those systems with the best-possible, most secure features in the first place. Additionally, the use of asymmetric encryption for the purpose of privacy and cryptographic access control over sensitive information has become a routine practice in nearly every industry due to widespread use of computers and the Internet.

Current systems suffer from a common security flaw resulting from the practical risk of private key theft and problems associated with the process of creating digital signatures and distributing digitally-signed information, particularly when such information is intended to be used automatically as in a data processing context or when such information takes the form of computer programming instructions. In addition to the risk of theft, a private key can be discovered by a third-party, computationally, through cryptanalytical methods. Popular belief is that such cryptanalytical discovery is improbable as a result of the cryptographic key strength of the asymmetric cryptosystems involved in digital signatures or asymmetric encryption. However, new methods are constantly emerging that make it increasingly likely that private keys can be discovered through cryptanalysis alone, without requiring an adversary to intercept all or part of any secret, or to find a way to steal the private key itself.

Partial solutions for problems of key theft have been developed, including key revocation or expiration, to revoke or cancel trust in compromised keys. Existing solutions create serious security problems that are revealed when certain trusted public/private key pairs used in digital signature systems are stolen or otherwise compromised or if there are avoidable design mistakes.

Revocation lists and expiration dates have served to minimize the window of exposure to the risk of stolen or cryptanalytically-compromised keys, particularly in systems that employ trust chains with a plurality of key pairs, digital certificates with such revocation lists, and certificate expiration events that are common or there is inherently a degree of distributed, automated trust.

Revoking or expiring a trusted key merely suspends the automatic trust previously extended to that key. Vulnerable systems typically provide the ability to continue to use an untrusted key even though that key has expired or been revoked.

End-users presently have no way to differentiate between a forged signature and a legitimate one, and so are inclined to give a digital signature the benefit of the doubt when the signature appears to verify as cryptographically-valid, even in the case where the private key used to create the digital signature has been designated expired or has been revoked.

Current programmable microprocessor-based electronic host systems allow unknown code to execute without the consent of the entity controlling the host system. Such hosts may include a system for updating programs on the host. This may be accomplished by an automatic update application, which automatically receives updates and installs them on the host system.

Such update systems represent a security threat because the update may have been tampered with or otherwise maliciously modified. Or, alternatively, the update may simply not function correctly, potentially leaving the host system inoperable. This is true even though some update systems provide for checking a digital signature associated with the update. The signer of the update may not be trustworthy or may have been compromised, rendering the signature effectively useless as a security mechanism to prevent introduction of unauthorized programs.

When a digital signature private key is compromised, as for example when an unauthorized party obtains a copy of the private key or when a business that owns a private key experiences a change in management that gives a new set of individuals access to the private key, there is no way for anyone to know what might happen next or who might end up in possession of a copy of the private key. Every system that contains the corresponding public key for the compromised private key and is designed to use the public key to verify digital signature data created using the compromised private key is, in effect, compromised. There is no way for such systems to tell the difference between an authorized use of the private key and an unauthorized use. This makes it clear that relying on a third-party digital signature as the basis of allowing updates to occur to a system that performs automatic updates is an unsafe practice that should be avoided if possible.

Unfortunately, systems that auto-update and depend on digital signature verification for preventing unauthorized updates from occurring don't provide additional security to compensate for the possibility that unauthorized updates may be received, anyway, and digital signature verification will appear to be successful, for example, because an attacker who sends a malicious update may have succeeded in obtaining the digital signature private key, corresponding to the public key that is used by the system, to digitally-sign such malicious updates. One defense against such a vulnerability is to avoid all manner of auto-updates, but that is often not practical and may introduce other more serious vulnerabilities such as the inability of a vulnerable system to receive an urgent security fix in a timely manner from a system vendor.

### BRIEF SUMMARY OF THE INVENTION

Certain embodiments of the present invention provide a cryptographic system that enables updates with digital signatures, the signatures being created using an improved digital signature scheme, or using a conventional digital signature scheme that uses a one-way hash function algorithm during digital signature creation and verification, the updates being digitally-signed by a customer in addition to potentially being digitally-signed by a vendor. The updates being either programming instructions or a cryptographic key. The digital signatures associated with the updates being stored in a customer signature repository. The updates being delivered to a customer host along with the associated digital signature retrieved from a customer signature repository. Digital signatures being verified on the customer host using a customer public key. Acceptance of the updates being dependent on successful digital signature verification.

### BRIEF DESCRIPTION OF SEVERAL VIEWS OF THE DRAWINGS

FIG. 1 illustrates a system for digitally-signed updates according to an embodiment of the present invention.

FIG. 2 illustrates a system for digitally-signed updates according to an embodiment of the present invention.

FIG. 3 illustrates a flow diagram for a method for digitally-signed updates according to an embodiment of the present invention.

FIG. 4 illustrates two exemplary systems for digitally-signed updates according to embodiments of the present invention.

FIG. 5 illustrates two exemplary systems for digitally-signed updates according to embodiments of the present invention.

FIG. 6 illustrates a system for digitally-signed updates according to an embodiment of the present invention.

FIG. 7 illustrates a system for digitally-signed updates according to an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments of the present invention provide for customer-signed updates. Certain embodiments provide for customer-issued updates. Certain embodiments provide for secure customer signature catalogs for profiling and detection or prevention of unwanted vendor code.

Embodiments of the present invention provide a solution to various security problems inherent to the use of typical digital signature schemes when those schemes are employed to verify the authenticity of programming instructions for a microprocessor or a computer rather than the sort of information that the designers of typical digital signature schemes explicitly mention in prior art disclosures. Typically, digital signature schemes in the prior art have been directed at the problem of verifying messages that contain words or other information rather than being directed at the problem of verifying the authenticity of programming instructions. Security defects in the design and use of digital signatures are of extreme importance to any system that relies on digital signatures for verifying the authenticity or the origin of programming instructions because a security failure in this context results in an unauthorized third-party having potentially complete, unrestricted control over microprocessors embedded in electronic devices, or complete control over the operations of entire computer systems, or control over entire networks of computers.

To find a hash collision that will have a specific malicious effect on a computer system, or cause a microprocessor to do what an attacker wants it to do, is relatively easy compared to how difficult it is for an attacker to discover a hash collision between a first authentic message such as one written in English when encoded in ASCII consisting of the words “We are agreed” and a second malicious message consisting of a word or words that have a different meaning but also appear to be written in English, when encoded in ASCII, such as “No I disagree” or “no, thank you” where the second malicious message results in exactly the same hash code value as the authentic message. Such example hypothetical hash collisions are considered the worst-case scenario by cryptographers who have conceived and designed the prior art, and they have developed digital signature schemes that are very good at preventing this sort of hash collision between similarly-structured messages, for example written communication between persons.

It is generally believed, among cryptographers, that any hash collision that is found for a well-designed hash algorithm is of no practical concern or won't successfully deceive anyone because any hash collision that is discovered will take the form of a message that does not appear to remotely resemble the form or substance of the original authentic message. For example, a hash collision may be discovered for a message written in English, encoded in ASCII, with the content “We are agreed” but the hash collision will be a message that is either not encoded in the ASCII character set at all, or the message will be something like “#B7.?%p8*@@31” instead of anything resembling the original English message. Note that each message in the above examples consists of 13 characters to keep the discussion closer-to-life. Typical prior art hash algorithms used in digital signature schemes are often designed to incorporate the length of the information, in bytes, as a factor that influences the resulting hash code so that it is possible for the algorithm to prevent messages of arbitrary length from resulting in hash codes that collide. In other words, only a message of exactly the same length could potentially become a hash collision with a first authentic message, based on the design of certain prior art hash algorithms.

However, it is realized by the design of the present invention that what is a relatively minor or inconsequential impact of a hash collision for a typical digital signature scheme when used for verifying digital signatures of English-language messages, where a hash collision only finds some other message with the same hash code but the message is unintelligible to a human and bears no similarity whatsoever to the authentic message that was originally digitally-signed therefore won't be likely to deceive humans who are using digital signatures to help certify the authenticity of personal communications, is of extremely serious security consequence to a system that uses digital signatures to verify the authenticity of programming instructions or cryptographic keys. A unexpected, important discovery that there is something wrong with using classical digital signatures for signing software programs, updates to software programs, or cryptographic keys, led to innovative research work that was supportive to the present invention.

In the case of digital signatures for programming instructions, software programs, scripts that are designed to be interpreted by an automated processing system to instruct or carry out actions or computations, bytecode-based systems such as Java, or other virtual machine-based systems, and also in the case of cryptographic keys, there is often no such thing as an inoperable bit sequence. In other words, because a microprocessor or computer system assigns a meaning of some kind to every possible arbitrary sequence of bits, and typically will attempt to make use of the arbitrary sequence of bits without preprocessing to enforce any particular structure ahead of time, finding a hash collision for a digital signature that has been computed using a typical hash code-based digital signature scheme results in the ability of an attacker to force a microprocessor to do something other than what was intended, simply by supplying a replacement bit sequence an attacker has found that results in a hash collision and therefore will pass signature verification.

An embodiment of the present invention provides for a solution to the problem of creating or verifying digital signatures, when for example messages being digitally-signed are programming instructions, software, or cryptographic keys, where arbitrary bit sequences are still meaningful. In an embodiment of the present invention, programming instructions, software, or cryptographic keys are encrypted using the customer private key. The resulting ciphertext is a digital signature.

In addition to providing a solution to this problem of unsafe hash codes in digital signature schemes when they are used to sign certain messages, certain embodiments of the present invention provide a way for users, administrators, and others who may be considered customers, to indicate acceptance of a software vendor's updates by associating a customer digital signature with those updates. Enhanced security and control over a customer host is achieved by preventing the host from installing or executing vendor updates unless an associated digital signature can first be verified.

Certain embodiments enable a customer to include their own updates to a system, along with associated digital signatures created by using the customer's private key, so that a single update mechanism can be realized whereby any update desired by a customer for a customer host can be delivered through a server. Security is also improved with improved design of digital signatures.

Certain embodiments enable a customer to create their own custom software, programming instructions, or other updates and upload these customer updates to a download server for future distribution to a customer host possibly through update servers or a customer local update server.

Certain embodiments provide a defense against the vulnerability discussed above of compromised updates digitally-signed by third-parties. More particularly, certain embodiments enable the owner of a system to create their own digital signatures using a private key that is wholly different from the private key used by a system vendor to digitally-sign vendor updates.

In certain embodiments, when updates are received by the system, the public key that corresponds to the system owner's private key can be used to verify the digital signature associated with the update. This gives the system a way to auto-update, but ensures that every update that is received by the system has been authorized, explicitly, in advance of the update being received by the system, by the owner of the system. In the event that the owner's digital signature private key is compromised, the impact is limited to the systems that rely on that particular private key, and the owner need not use a single private key for all of the systems they own that perform auto-update.

A general purpose programmable computer typically incorporates a programmable microprocessor that is controlled by programming instructions and will generally, by design, do whatever the programming instructions instruct it to do. This gives rise to a number of security problems that are well-known in the prior art, such as computer virii and other forms of malicious software. A programmer of such a computer is able, by carefully examining every programming instruction and all information supplied to the programmable microprocessor, to reliably differentiate between programming instructions that are desired and those which are not. A programmer can also reliably identify unwanted information before it is used for computation.

However, users of programmable computers are not capable of doing either of these things, so users are at risk from both unwanted programming instructions and unwanted information. When a user mistakenly allows or instructs a computer to execute unwanted programs or process malicious information, a third-party may be able to take control of the computer being used. Even in the case of programmers who possess the ability to verify that programming instructions and information are desired for use by a microprocessor before allowing those instructions or that information to be processed by the microprocessor, examining every instruction and every bit of information processed by a computer is prohibitively time-consuming and difficult.

As embodiments of the present invention demonstrate, however, it is possible for certain programming instructions and information to be

A digital signature is created by transforming a plaintext message using a private key, such that a corresponding public key is required in order to verify the digital signature by performing a second transformation and a comparison. The first transformation of the message typically results in a hash code of the message, which hash code is encrypted using a first key. The comparison is typically the decryption of the hash code using a second key that corresponds to the first key followed by comparing the decrypted hash code to the hash code that is obtained by once again hashing the message using the same one-way function hash algorithm. The expected result of such comparison is that the decrypted hash code should match the hash code computed again by hashing the message. Unless a hash collision occurs, these cryptographic transformations and the resulting comparison tend to confirm that the message that was signed is the same as the message that was received along with the digital signature data.

Typically, in most digital signature schemes, the plaintext data that is obtained by using the public key to decrypt the ciphertext of the digital signature is a hash code of the message that was digitally signed rather than a full and complete copy of the message that was digitally signed. In a typical digital signature scheme, a “digital signature” is essentially an encrypted hash code, though there is often additional data contained within the digital signature as well. Decrypting the hash code enables the digital signature verification process to verify that the message it received is probably the same message that was digitally signed by the entity in possession of the private key used to formulate the digital signature. In the case of a forged digital signature an adversary has potentially discovered the private key, and so has gained the ability to form verifiable digital signature ciphertext by encrypting arbitrary hash codes such that the recipient will be able to decrypt to verify these encrypted hash codes, when decrypted, correspond to the hash code that is expected for an arbitrary message chosen by the adversary, exactly as the recipient would verify any legitimate digital signature. This type of forged digital signature is exactly the same as any legitimate digital signature, it is considered “forged” only by virtue of the fact that somebody other than the authorized private key holder formulated the digital signatures for arbitrary messages that were not created nor sent by the authorized private key holder, and therefore are messages that presumably have some type of malicious purpose.

Alternatively, the adversary may have discovered a hash collision and used this discovery to forge a digital signature. A hash collision is any two or more messages that, when hashed according to a hash algorithm, result in identical hash codes. For instance, if a first message “hello world” hashes to a hash code of 31, it is possible that an adversary could discover a second message “goodbye world” that also hashes to a hash code of 31. Because the messages are, in general, longer than the length of the hash codes used in digital signature schemes it is known in the art of cryptology that hash collisions exist and that they are in fact very common. However, when we're dealing with a cryptographic system that transforms messages of arbitrary length into hash codes of fixed length we're dealing with seemingly-infinite numbers of possible combinations of bit sequences being condensed down to bit sequences that themselves have an enormous number of possible values. In this context, the existence of a few million billion hash collisions is considered statistically meaningless because nobody has the technical ability, yet, to try a seemingly-infinite number of possible messages searching for one of the few million billion possible messages that will result in a hash collision for a certain hash code, such as 31. With a hash code that is such a small number, of course, the difficulty of finding a hash collision is minimal, but hash algorithms typically use hash code values that are hundreds of bits in length.

Hundreds of bits makes for an enormous number of possibilities, but when messages are thousands or tens of thousands or hundreds of thousands of bits in length it is obvious that the number of hash collisions that must exist in reality are very large. The larger the message in relationship to the length of the hash code, the larger the number of hash collisions there must be.

Importantly, every single digital signature that is created using a hash code-based digital signature scheme is potentially reusable as a verifiable digital signature for every single one of the messages that share the same hash code as the digitally-signed message. In other words, the formulation of a digital signature using a hash code encrypted by a private key is the same thing as digitally-signing a few million billion messages using that private key, if that's the number of hash collisions that exist for a given message length and hash code length under a particular hash code algorithm. For this reason most digital signature schemes employ additional verification mechanisms such as using more than one hashing algorithm (reducing the likelihood that anyone will ever be able to discover a message that has two hash collisions in common with an authentic digitally-signed message) or use timestamps and other information security defenses to prevent the “replay” of an authentic digital signature by an adversary.

As discussed above, a key may be either a numeric value or an algorithm. Keys may be public, private, or secret. A public key and a private key are related to each other, mathematically, or by way of their algorithm design. A secret key stands alone as a numeric value or algorithm that is required for any cryptographic transformation to occur. A secret key is not related to another key. Cryptographic transformations made with a secret key are said to be reversible with that same key, whereas transformations made with either a public key or a private key are only reversible using the corresponding related key. Public key and private key cryptosystems are also known as asymmetric, while cryptosystems that employ secret keys are known as symmetric cryptosystems owing to symmetry between encryption and decryption keys.

Certain embodiments of the present invention provide a cryptographic command and control system that delivers instructions in the form of messages that include associated, attached, or embedded digital signatures. The instructions may be considered an update for a system, as discussed above. The system relies on its ability to verify the digital signature associated with a given message to confirm that the message is trusted before relying on the contents of the message. When a digital signature is created, a digital signing process is used. When a digital signature is verified by the recipient of a signed message, a digital signature verification process is used. The digital signature creation and verification may utilize cryptographic keys.

There are numerous ways for the owner of a system to examine the updates that become available from a system vendor, and numerous ways for the decision to approve or disapprove a particular update to be made on a case-by-case basis. Certain embodiments of the present invention allow an owner to successfully defend against a malicious update that appears to have a verifiable digital signature attached that was created using the system vendor's private key by implementing approve/disapprove preupdate defensive analysis as routine security policy procedure for an updating system. The decision to perform such preupdate analysis and approve or disapprove individual updates only opens a new can of worms, however, because update servers that deliver updates for vendors' products don't allow the owners of systems that receive such vendor updates to preauthorize the updates by obtaining specimens of the updates, performing analysis or quality assurance testing, and creating a digital signature to authorize the automated update which is a shortcoming of current systems that requires an innovative solution.

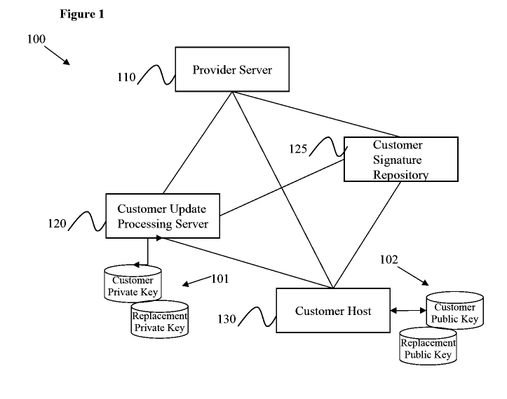

FIG. 1 illustrates a system 100 for digitally-signed updates according to an embodiment of the present invention. The system 100 includes a provider server 110, a customer update processing server 120, a customer signature repository 125, and a customer host 130.

The provider server 110 is in communication with the customer update processing server 120 and the customer host 130. In certain embodiments, the customer host 130 is in communication with the customer update processing server 120.

In certain embodiments, the system 100 includes a customer signature repository 125. The customer signature repository 125 may be in communication with the provider server 110, the customer update processing server 120, and possibly the customer host 130, when present. In certain embodiments, the customer signature repository is integrated into the provider server 110. In certain embodiments, the customer signature repository is integrated into the customer update processing server 120. In certain embodiments the provider server 110, the customer update processing server 120, and the customer signature repository 125 are all part of the same server.

In operation, the customer update processing server 120 receives an update. The customer update processing server 120 may then digitally sign the update with a customer private key to create a customer update signature. In certain embodiments, the digital signature may be created by encrypting the entire update using the customer private key so that the customer public key can be used to decrypt the update, which then becomes the expected update just as a decrypted hash code value typically becomes the expected hash code in other digital signature schemes, and a comparison can be done that verifies the digital signature of the update by determining if there is an exact match between the update and the expected update. In certain embodiments, the digital signature may be created using a typical digital signature scheme that uses a one-way hash function algorithm to compute a hash code of the update and then encrypt the hash code using the customer private key. The customer update signature may then be communicated to the provider server 110. The customer host 130 may then receive the update from the provider server 110 together with the associated customer update signature. If the update is correctly verified using the customer update signature verification public key accessible to the customer host 130 by way of customer public key storage 102, then the update may be installed on the customer host 130. The customer update processing server 120 is able to create digital signatures that can be verified using the customer update signature verification public key by virtue of having access to the customer private key as in customer private key storage 101.

The customer update processing server 120 and the customer host 130 may be controlled by an entity other than the entity that controls the provider server 110. For example, the provider server 110 may be a company such as PivX which provides information security services to customers. The customer update processing server 120, customer signature repository 125, and the customer host 130 may be controlled by a separate company utilizing the services of the company controlling the provider server 110. Likewise, customer host 130 may be controlled by its owner while the customer update processing server 120 and customer signature repository 125 are controlled by a second entity, and still a third entity may control provider server 110.

The customer update processing server 120 is adapted to receive an update. The update may be received from the provider server 110, for example. The update may be received over a network such as a virtual private network (VPN) or the Internet, for example. The update may be received wirelessly, for example. The update may be provided to the customer update processing server by the customer, for example by way of a CD-ROM, DVD, or flash memory. The update may be provided to the customer update processing server by electronic communications initiated by the customer, for example by way of electronic mail or file transfer.

The update may include a patch, fix, modification, and/or revision of a piece of software, for example. As another example, the update may include a stand-alone software program, data file, and/or executable. As another example, the update may include a component, plug-in, and/or module for a software program such as a brand-new module that may be added to the software by update. In certain embodiments, the update is created by the entity that controls the provider server 110. For example, the update may be a provider update. In certain embodiments, the update is created by the entity that created the software package the update is for. The update may also be designed to operate with a compatible software package. For example, the update may be a third-party update. In certain embodiments, the update is created by the entity that controls the customer update processing server 120 and the customer host 130. For example, the update maybe a customer update that is newly-created and originally-issued by the customer for their own use.

The update may include and/or be associated with a digital signature. That is, the update may be provided with and/or be associated with a digital signature. The digital signature may be a cryptographic signature, for example. For example, the digital signature may be generated by applying a private key to a message digest generated from the update using a hashing algorithm. The digital signature may be created by the entity that created the update, for example. As another example, the digital signature may be created by the entity that controls the provider server 110. In certain embodiments, the digital signature may be created by the customer.

The update may be received by the customer update processing server 120 which may store the update in the form of programmable hardware circuitry such as a Field Programmable Logic Array (FPLA) or an Application Specific Integrated Circuit (ASIC) or a Read Only Memory (ROM) or smart card. The customer update processing server 120 may cause such a hardware integrated circuit device to be prepared for physical delivery to customer host 130 for activation.

Customer update processing server 120 may be a local update server operable by a customer.

After receiving the update, the customer update processing server 120 may verify the update based on a digital signature included in and/or associated with the update. If the digital signature associated with the update does not correctly verify using the appropriate digital signature verification public key, the customer update processing server 120 may ignore or flag the update. Security incident response rules may be triggered when a signature fails to verify, for example.

The customer update processing server 120 is adapted to generate a customer update signature for the received update. The customer update signature may be a cryptographic signature, for example. For example, the customer update signature may be generated by using a private key of the customer to encrypt a message digest hash code generated from the update using a hashing algorithm.

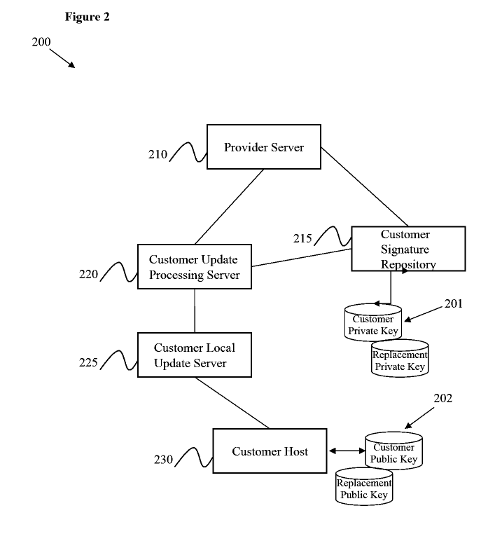

Once the customer update signature has been generated, the customer update processing server 120 communicates the customer update signature to a server. In certain embodiments, the server is the provider server 110. In certain embodiments, the server is in communication with a customer signature repository. In certain embodiments, the server is a customer local update server. An example of such an embodiment is described in more detail below with reference to FIG. 2.

In certain embodiments the customer update signature is communicated to a customer signature repository 125. The customer signature repository 125 may be implemented as a stand-alone server. Alternatively, the customer signature repository 125 may be part of the provider server 110, the host 130, or the customer update server. The discussion herein assumes the customer update repository is part of the provider server 110, but as mentioned, it may be implemented in other ways. The customer signature repository 125 is adapted to store a customer update signature. The customer signature repository 125 is further adapted to provide a customer signature to the host 130.

The customer update signature may be communicated with and/or included in the update, for example. As another example, a copy of the update may already reside on the server, and the customer update processing server 120 may communicate just the customer update signature to the server to be associated on the server with the update.

The customer host 130 may then receive an update from the server. For example, the customer host 130 may receive the update from the provider server 110. As another example, the customer host 130 may receive the update from a customer update server. The update may include the customer update signature, for example. As another example, the customer host 130 may separately receive a customer update signature associated with the update.

The customer host 130 may be a workstation, server, and/or mobile device, for example.

The customer host 130 is adapted to verify the update. The customer host 130 may verify the update based on the customer update signature, for example. If the customer update signature is correctly verified, then the update may be installed on the customer host 130. In certain embodiments, the customer host 130 verifies the update based on the customer update signature and a digital signature created by an entity other than the customer.

In certain embodiments, if the update received by the customer host 130 does not include and/or have an associated customer update signature, the customer host 130 will not install the update. For example, if the update is a low-priority update, the customer host 130 may not install it if it has not been signed by the customer update processing server 120. However, in some embodiments, the customer host 130 may install the update even if it does not include and/or is not associated with a customer update signature. For example, if the update is a high-priority update, the customer host 130 may install it if it includes a verifiable digital signature, other than the customer digital signature, not generated by the vendor who created the update.

FIG. 2 illustrates a system 200 for digitally-signed updates according to an embodiment of the present invention. More particularly, FIG. 2 illustrates an embodiment where the customer update processing server 220 communicates the update to the customer local update server 225. The system 200 includes a provider server 210, a customer signature repository 215, a customer update processing server 220, a customer local update server 225, and a customer host 230.

The customer update processing server 220 is in communication with the provider server 210, the customer signature repository 215, and the customer local update server 225. The customer local update server 225 is in communication with the customer host 230.

The provider server 210 may be similar to the provider server 110, described above, for example. The customer signature repository 215 may be similar to the customer signature repository 125, described above, for example. The customer update processing server 220 may be similar to the customer update processing server 120, described above, for example. The customer host 230 may be similar to the customer host 130, described above, for example.

In operation, the customer update processing server 220 generates a customer update signature for an update received from the provider server 210. The customer update processing server 220 communicates the customer update signature to the customer signature repository 215. The customer update processing server 220 then communicates the customer update signature to the customer local update server 225. In addition, if the update is not already present on the customer update server 225, the customer update processing server 220 may communicate the update to the customer local update server 225 as well. The customer host 230 then receives the update from the customer local update server 225 and verifies the update based on the included and/or associated customer update signature. If the customer update signature is correctly verified, then the customer host 230 may install the update. In certain embodiments the customer update processing server 220 communicates with the provider server to review and approve updates available from the provider server 210, causing the provider server 210 to generate a customer update signature. In certain embodiments the customer signature repository 215 has access to a customer private key storage 201 and the customer signature repository generates the customer update signature using the customer private key.

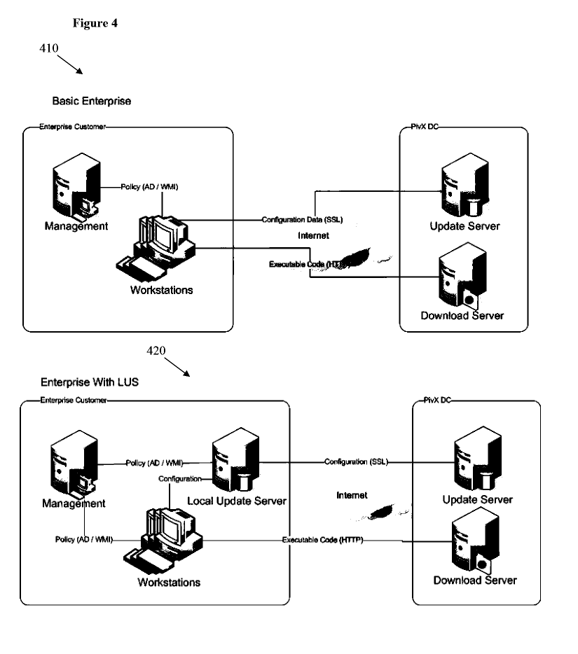

FIG. 4 illustrates two exemplary systems 410,420 for digitally-signed updates according to embodiments of the present invention. The data center (DC) of a provider, or of a vendor, whom supplies updates may, in some embodiments, be configured to communicate both with customer hosts, as 130 or 230 above, and a customer local update server, as 125 above. In a basic enterprise embodiment workstations, such as computers running a Windows operating system, may be customer hosts, as 130 or 230 above, and those customer hosts may communicate with a provider server by way of Secure Sockets Layer (SSL) and may also communicate with another provider server by way of Hypertext Transfer Protocol (HTTP) simultaneously or in sequence. An update server as depicted in FIG. 4 may send and receive configuration data including customer signatures. An update server may access a customer signature repository 215 or 125. A second provider server may provide updates to customer hosts 130 or 230. Because the update signatures cannot be forged except by way of theft of the customer private key, encryption and authentication services of SSL aren't necessary when receiving updates from a download server.

System 420 depicted in FIG. 4 shows an improvement that gives more control over update procedures and policy, preventing customer hosts 130 or 230 from communicating directly with the update server, which is a provider server as in 110 or 210 above, and instead allowing a customer local update server, as in 225 above, to provide customer signatures to customer hosts. In some embodiments the customer local update server also provides updates to customer hosts.

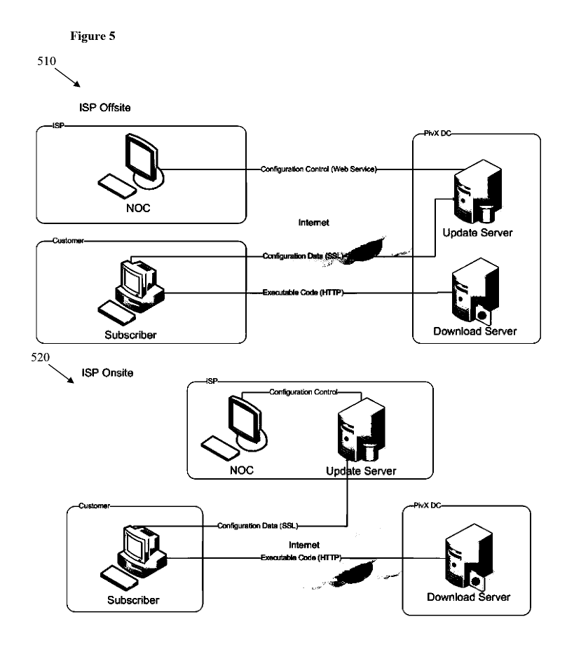

FIG. 5 illustrates two exemplary systems 510,520 for digitally-signed updates according to embodiments of the present invention. In system 510, a subscriber of an Internet Service Provider (ISP) receives an embodiment of the invention wherein the ISP has configuration control over the operation of the system, including possibly having the ability to create customer signatures. In certain embodiments, the customer private key storage 101 or 201 is located in the Network Operations Center (NOC) belonging to an ISP, for example. In certain embodiments the customer private key belongs to an ISP rather than belonging to the owner of a customer host 130 or 230, as in embodiments depicted in FIG. 5 where a subscriber owns the host 130 or 230. In such embodiments the customer host 130 or 230 will have access to the ISP's public key.

System 520 shows an embodiment wherein a provider server 210 is located within the ISP accessible to the NOC for the purpose of controlling configuration of the system including delivery of customer update signatures to subscriber hosts as shown. The provider server 210 located within the ISP functions in this embodiment as a customer update processing server 220 also. In certain embodiments, the ISP update server may communicate with the download server and then provide updates in addition to customer update signatures to subscriber hosts as shown.

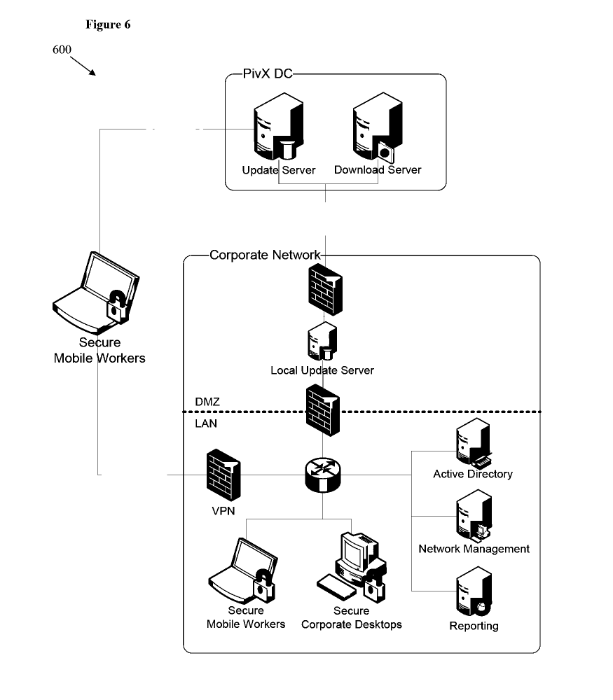

FIG. 6 illustrates a system 600 for digitally-signed updates according to an embodiment of the present invention. System 600, shown in FIG. 6, is similar to system 200 in FIG. 2, but with the additional feature that some of the customer hosts 230 may be mobile hosts such as laptop computers. When the mobile hosts do not have access to the customer local update server, similar to 225 above, those mobile hosts may operate similar to how a customer host 130 does in an embodiment, such as system 100, wherein there is no customer local update server and the customer host 130 instead communicates with a provider server 110.

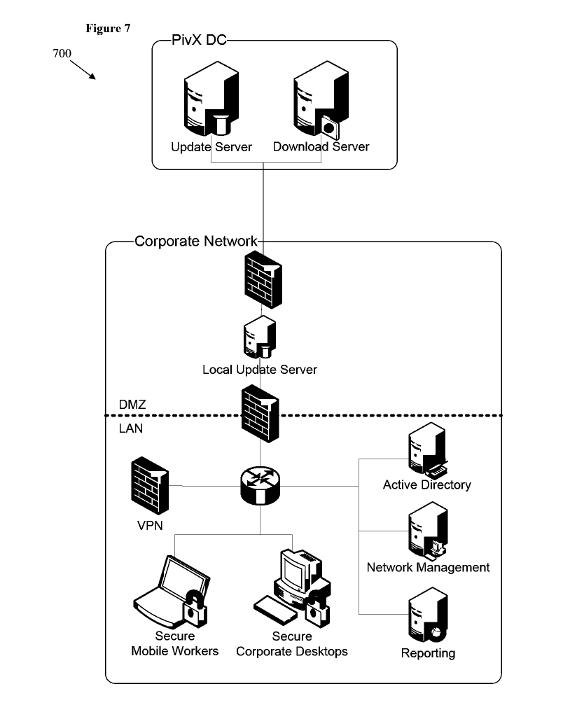

FIG. 7 illustrates a system 700 for digitally-signed updates according to an embodiment of the present invention. System 700, shown in FIG. 7, is similar to system 600 in FIG. 6, but without the addition of mobile customer hosts 230 that are able to operate in a manner similar to the way that either customer hosts 130 or customer hosts 230 operate, wherein these mobile customer hosts are able to communicate either with the customer local update server or with the provider server, as in 110 or 210 above. The system 600 illustrates that in some embodiments it may be advantageous to prevent such mobile hosts from communicating with any provider server 110 or 210, and instead requiring such mobile hosts to communicate only with customer local update server 225.

The components, elements, and/or functionality of the systems 100, 200, 410, 420, 510, 520, 600, and/or 700 may be implemented alone or in combination in various forms in hardware, firmware, and/or as a set of instructions in software, for example. Certain embodiments may be provided as a set of instructions residing on a computer-readable medium, such as a memory or hard disk, for execution on a general purpose computer or other processing device. Certain embodiments may be provided in the form of Field Programmable Logic Arrays (FPLA) or Application Specific Integrated Circuits (ASIC) semiconductors, smart cards, Read Only Memory (ROM) or conventional integrated circuits. Certain embodiments may communicate by way of wireless radio frequency signals including but not limited to cellular, WiFi, WiMax, mesh network topologies, satellite transceiver, or other wireless communications technology.

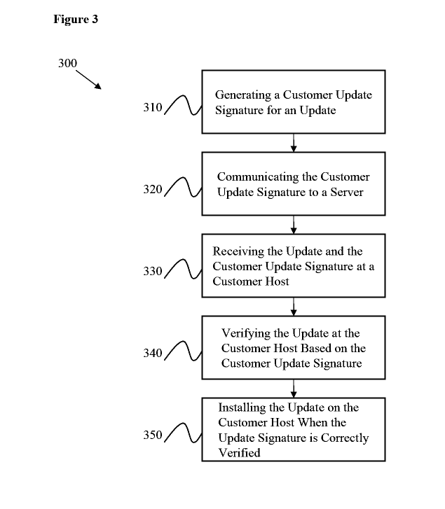

FIG. 3 illustrates a flow diagram for a method 300 for digitally-signed updates according to an embodiment of the present invention. The method 300 includes the following steps, which will be described below in more detail. At step 310, a customer update signature is generated for an update. At step 320, the customer update signature is communicated to a server. At step 330, the update and the customer update signature are received at a customer host. At step 340, the update is verified at the customer host based on the customer update signature. At step 350, the update is installed on the customer host when the digital signature associated with the update is correctly verified. The method 300 is described with reference to elements of systems described above, but it should be understood that other implementations are possible.

At step 310, a customer update signature is generated for an update. The customer update signature may be generated by a customer update processing server similar to the customer update processing server 120 and/or 220, described above, for example. In certain embodiments, the update is a provider update. In certain embodiments, the update is a customer update. In certain embodiments, the customer update signature is generated by a customer.

At step 320, the customer update signature is communicated to a server. The server may be a provider server or a customer server, for example. In certain embodiments, the server includes a signature repository. The signature repository may be similar to the signature repository 125 and/or 225, described above, for example. In certain embodiments, the signature repository is accessible to a customer server. In certain embodiments, the signature repository is accessible to a provider server. In certain embodiments, the signature repository is part of a customer host.

At step 330, the update and the customer update signature are received at a customer host. The customer host may be similar to the customer host 130 and/or 230, described above, for example, or the customer host may be a mobile customer host with similarities to both 130 and 230 as illustrated in system 600, above.

At step 340, the update is verified at the customer host based on the customer update signature. The customer host may be similar to the customer host 130 and/or 230, described above, for example.

At step 350, the update is installed on the customer host when the digital signature associated with the update is correctly verified. The customer host may be similar to the customer host 130 and/or 230, described above, for example.

One or more of the steps of the method 300 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. Certain embodiments may be provided in the form of Field Programmable Logic Arrays (FPLA) or Application Specific Integrated Circuits (ASIC) semiconductors, smart cards, a Read Only Memory (ROM) or conventional integrated circuits. Certain embodiments may communicate by way of wireless radio frequency signals including but not limited to cellular, WiFi, WiMax, mesh network topologies, satellite transceiver, or other wireless communications technology.

Certain embodiments of the present invention create digital signatures for programming instructions, software, or cryptographic keys already installed on a system such as customer host 130 or customer host 230. Customer signatures thus created are sent to a customer signature repository such as customer signature repository 125 or customer signature repository 215 above.

Certain embodiments of the present invention operate in a “hosted” mode of operation for the customer signature generation, wherein a user interface such as a web page or specialized client software enables a user of the system to review information about vendor updates, programming instructions, software, or cryptographic keys that are already installed on a system such as customer host 130 or customer host 230. In such embodiments, a server adapted to communicate with the client software or a web browser client allows a user to request that digital signatures be created for selected items and request that those signatures be stored in a customer signature repository, such as customer signature repository 125 or customer signature repository 215 above. In such embodiments, the key storage for the customer private key, such as key storage 101 or key storage 201 described above, may be accessible to a server, such as provider server 110 or provider server 210 as described above, to facilitate signature creation on a server.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments of the present invention provide systems and methods for digitally-signed updates. Certain embodiments provide for customer-signed updates. Certain embodiments provide for customer-issued updates. Certain embodiments of the present invention provide a technical effect of digitally-signed updates. Certain embodiments provide a technical effect of customer-signed updates. Certain embodiments provide a technical effect of customer-issued updates. Certain embodiments of the present invention enable the updates to be larger than the size of the private key that is used to digitally-sign the updates. A key that is smaller than a message can only be used to encrypt the message through the application of some cryptographic algorithm for doing so. In the embodiments of the present invention where design limitations do not prevent doing so, standard cryptographic techniques such as cipher-block chaining (CBC) or electronic codebook (ECB) for block cipher repetitive cryptographic transformations may be employed to accomplish the encryption and decryption of message data and digital signatures as described herein. Note that using a private key in a block cipher ECB mode of operation is acceptable in certain embodiments of the present invention because resistance to cryptanalysis for privacy protection of the encrypted data is of little or zero concern, considering that in certain embodiments the full plaintext message is sent along with the digital signature, and methods of message encryption with the private key are used only for digital signature verification, not for message privacy.

A modified improved digital signature scheme derived from the one taught herein may reduce the length of the digital signature either by compressing the original message before encrypting it with the customer private key, and correspondingly decompressing the compressed message or repeating the compression again during digital signature verification subsequent to decrypting the ciphertext of the digital signature using the customer public key, or by compressing and decompressing the ciphertext according to a reversible lossless compression algorithm.

Furthermore, a modified improved digital signature scheme derived from the one taught herein may use an appropriate lossy compression algorithm or intentionally discard up to half of the message prior to compressing and/or encrypting the message to form the digital signature ciphertext. Reduction in message size by up to half prior to forming the digital signature may be advantageous for some embodiments while not exposing as many collisions as with one-way hash function algorithms. For example, discarding every second bit of the message will result in exactly two collisions for each bit that is discarded, or exponential (2̂(message bit length/2)) possible collisions, a significantly smaller number of collisions than are known to exist for most cryptographic hash algorithms typically used for signing messages in digital signature schemes. Care must be exercised when deciding whether to reduce the message size for obvious reasons. The simple rule of discarding every second bit makes the discovery of collisions trivial. The purpose of one-way hash functions is not to prevent collisions but to make it computationally difficult to discover them. In applications where it would be harmful for an attacker to be able to choose every second bit in a malicious replacement message derived from an authentic message there should either be no reduction in message length and the entire message should be encrypted using the digital signature private key, or a cryptographic hash algorithm should be employed if reducing the length of a digital signature relative to the length of the signed message is desirable.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for digitally-signed updates, the method including:
generating a customer update signature for an update;
communicating the customer update signature to a signature repository;
receiving the update at a customer host; and
verifying the update at the customer host based on the customer update signature.

2. The method of claim 1, wherein the update is a provider update.

3. The method of claim 1, wherein the update is a customer update.

4. The method of claim 1, wherein the signature repository is accessible to a provider server.

5. The method of claim 1, wherein the signature repository is accessible to a customer server.

6. The method of claim 1, wherein the signature repository is part of the customer host.

7. The method of claim 4, wherein the customer update signature is generated by a customer.

8. The method of claim 5, wherein the customer update signature is generated by a customer.

9. The method of claim 1, wherein the customer update signature is generated by a customer.

10. The method of claim 9, wherein the update is a provider update.

11. The method of claim 9, wherein the update is a customer update.

12. The method of claim 1, wherein the customer update signature is generated for the update at a customer update processing server, wherein the customer update processing server received the update from a provider server, wherein the customer update signature is communicated to a signature repository accessible to the provider server, and wherein the customer host receives the update and the customer update signature from the provider server.

13. The method of claim 1, wherein the customer update signature is generated for the update at a customer update processing server, wherein the customer update processing server received the update from a provider server, wherein the customer update signature is communicated to a signature repository accessible to the customer update server, and wherein the customer host receives the update and the customer update signature from the customer update server.

14. The method of claim 12, wherein the customer update processing server is the provider server.

15. The method of claim 13, wherein the customer update processing server is the provider server.

16. The method of claim 1, further including installing the update on the customer host when the customer signature is correctly verified.

17. The method of claim 1, further including executing the update on the customer host when the customer signature is correctly verified.

18. A system for digitally-signed updates, the system including:
a customer update processing server adapted to generate a customer update signature for an update, wherein the customer update processing server communicates the customer update signature to a server;
a customer host adapted to receive the update and the customer update signature, wherein the customer host is adapted to verify the update based on the customer update signature.

19. A method of verifying a digital signature that is associated with a message, the method including:
decrypting ciphertext information using a decryption algorithm to generate plaintext information; and
verifying that the plaintext information that results from decrypting the ciphertext information exactly matches at least half of the information contained in a message that is associated with a digital signature.

20. The method of claim 19, wherein the message is one of programming instructions for a microprocessor, programming instructions for a computer, software, firmware, the contents of a Read Only Memory, the configuration of a Field Programmable Logic Array, byte codes, scripts that can be interpreted or processed to cause an effect programmatically within a computer system, and the contents of a smart card memory.

21. The method of claim 19, wherein the message is a cryptographic key.
